(19) United States
(12) Patent Application Publication
(10) Pub. No.: US 2012/0023896 A1
(43) Pub. Date: Feb. 2, 2012

(54) AUXILIARY POWER UNIT FIRE ENCLOSURE DRAIN

(75) Inventors: Brian C. DeDe, San Diego, CA (US); David Lau, San Diego, CA (US); Walter Ernest Ainslie, Ramona, CA (US)

(73) Assignee: HAMILTON SUNDSTRAND CORPORATION, Windsor Locks, CT (US)

(21) Appl. No.: 12/847,343

(22) Filed: Jul. 30, 2010

(51) Int. Cl. F23M 11/00; F02C 7/00

(52) U.S. Cl. 60/39.094

(57) ABSTRACT

A drain assembly for an auxiliary power unit having a hot zone formed by a combustor case comprises a fire enclosure, a drain fitting and an orifice. The fire enclosure encapsulates the hot zone. The drain fitting connects to the fire enclosure. The orifice extends from the combustor case into the drain fitting to form an expansion joint.

### STATEMENT OF GOVERNMENT INTEREST

The U.S. Government has a paid-up license in this invention and the right in limited circumstances to require the patent owner to license others on reasonable terms as provided for by the terms of Contract No. N00019-06-0081 and Sub-Contract No. 4500019224 awarded by the United States Navy.

### BACKGROUND

The present invention is directed to auxiliary power units having fire enclosures. More particularly, the invention relates to connecting joints for mounting drains to fire enclosures in the auxiliary power unit.

Auxiliary power units (APUs) comprise gas turbine engines that operate to provide various power inputs to aircraft, such as helicopters, when the main propulsion engines are not operating, such as during ground operations or during the event of an outage during flight. APUs can additionally provide supplemental power to that generated during main engine operations. APUs typically comprise gas turbine engines having a compressor and a turbine, between which a combustor burns fuel. Through a gearbox, the turbine provides mechanical input to an electrical generator, while compressed air bled from the compressor is used to supply various environmental control systems.

APUs are typically located within the outer skin of the fuselage of the aircraft. Thus, it is desirable to encapsulate hot sections of the APU to provide a fire break where fuel is present. Conventional practice, such as is described in U.S. Pat. No. 7,526,921 to Williams et al., involves rigidly bolting a fire enclosure to various fixed positions on the APU. Temperature variations that arise during different operating cycles of the APU produce thermal expansions of various APU components that alter the distances between the fixed positions. Thermal growth of the APU thus induces strain into the fire enclosure. The ability of the fire enclosure to tolerate deflection or bending is limited because the fire enclosure is not a structural component designed to absorb loading.

Furthermore, it is desirable to be able to drain fuel from the combustor out of the fire enclosure in the event of unburned fuel being present in the combustor, such as from a failed start or some other occurrence. Previous attempts at providing drains on APU fire enclosures involved using check valves that needed to be actively closed to prevent combustor air from escaping during operation of the APU and then opened to drain fuel. These valves, however, typically failed to a closed position, which could lead to fuel pooling within the combustor causing a fire hazard. Other fire enclosures, such as described in the aforementioned patent to Williams et al., involve bleed air ports having bulb seals that require precise alignment of parts. There is, therefore, a need for a fire enclosure drain that can accommodate thermal growths and misalignments within APU fire enclosures.

### SUMMARY

The present invention is directed to a drain assembly for an auxiliary power unit having a hot zone formed by a combustor case. The drain assembly comprises a fire enclosure, a drain fitting and an orifice. The fire enclosure encapsulates the hot zone. The drain fitting connects to the fire enclosure. The orifice extends from the combustor case into the drain fitting to form an expansion joint.

### BRIEF DESCRIPTION OF THE DRAWINGS

FIG. 1 is a partial cross-sectional view of a fire enclosure of an auxiliary power unit having a drain assembly with an expansion joint.

FIG. 2 shows the expansion joint of FIG. 1 connecting the fire enclosure to the combustor case through the drain assembly.

### DETAILED DESCRIPTION

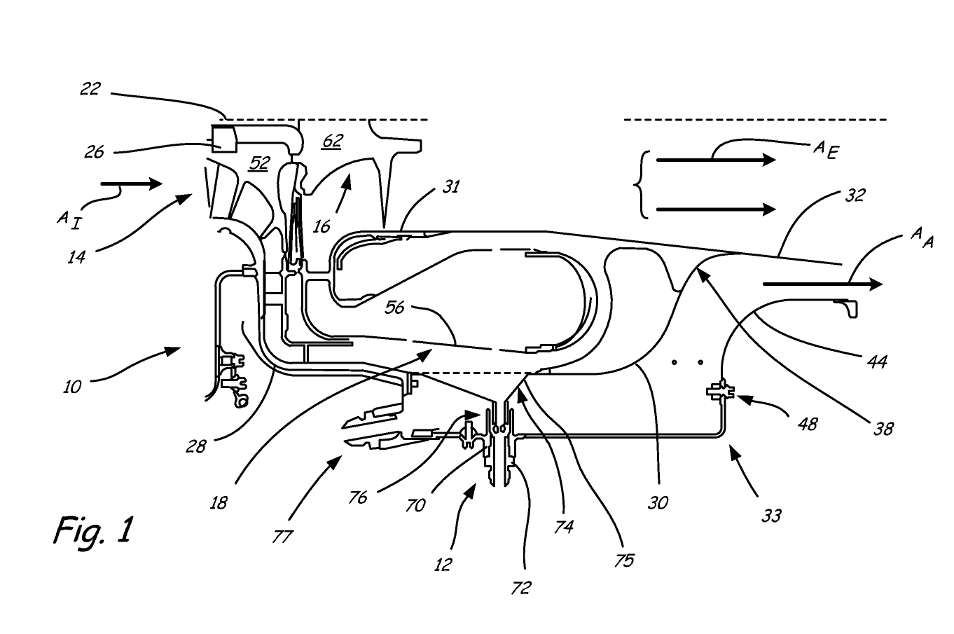

FIG. 1 is a partial cross-sectional view of an example auxiliary power unit (APU) 10 having fire enclosure drain assembly 12 of the present invention. APU 10 includes compressor section 14, turbine section 16 and combustor section 18. Compressor section 14, turbine section 16 and combustor section 18 comprise a gas turbine engine that may operate to provide mechanical input via shaft 22 to various components, such as an electrical generator (not depicted). Shaft 22 passes through compressor section 14, which is supported by bearings 26, and connects to turbine section 16. The gas turbine engine of compressor section 14, turbine section 16 and combustor section 18 is disposed within compressor case 28, combustor case 30, turbine case 31 and exhaust case 32. Compressor case 28, combustor case 30, turbine case 31 and exhaust case 32 form a serpentine flow path for air and gas that passes through the gas turbine engine. Fire enclosure 33 provides a containment shield for containing heat generated by combustor section 18 of the gas turbine engine and for containing flames generated by fuel vapors which come into contact with the outside of the combustor case 30. Drain assembly 12 permits fluid from inside combustor case 28 to drain outside of fire enclosure 33.

Fire enclosure 33 and the other engine casing components are connected by a plurality of joints that provide structural integrity to APU 10, while also permitting some of the cases to translate to absorb stresses generated during operation of APU 10. Exhaust case 32 connects with turbine case 31. Combustor case 30 connects with exhaust case 32. Fire enclosure 33 connects with compressor case 28. Exhaust case 32 connects with fire enclosure 33 through aft support ring 44 and joint 48. Fire enclosure 33 provides a fire wall or fire break between the hot section of APU 10 and the surrounding environment. Drain assembly 12 also includes an expansion joint that permits relative radial and axial displacement between fire enclosure 33 and combustor case 30.

Compressor case 28 comprises an annular body for housing compressor wheel 52 and compressor blades 54. Compressor case 28 has a converging inlet between outer and inner walls that comprise a passageway for conducting inlet air A_{I} through compressor section 14. Combustor case 30 comprises a single walled annular body having a generally cylindrical side-wall portion and a radially converging end portion that houses combustor liner 56. The side-wall portion generally traverses the axial length of combustor liner 56 while the radially converging portion generally traverses the radial extent of combustor liner 56. Combustor case 30 directs airflow from compressor case 28 into combustor liner 56.

Turbine case 31 comprises an annular body for housing turbine wheel 62. Turbine case 31 has a diverging inlet between outer and inner walls that comprise a passageway for conducting compressed inlet air A_{I} through turbine section 16. Turbine case 31 connects to the outlet of combustor liner 56 such that combustor liner 56 is encapsulated between compressor case 28, combustor case 30, exhaust case 32 and turbine case 31. Turbine case 31 directs airflow from combustor section 18 to exhaust case 32. Exhaust case 32 comprises a cylindrical body having a generally straight upstream section and a slightly diverging downstream section. Exhaust case 32 extends into combustor section 18 and traverses the axial length of combustor liner 56. Exhaust case 32 directs exhaust air A_{E} from turbine section 16 out of APU 10.

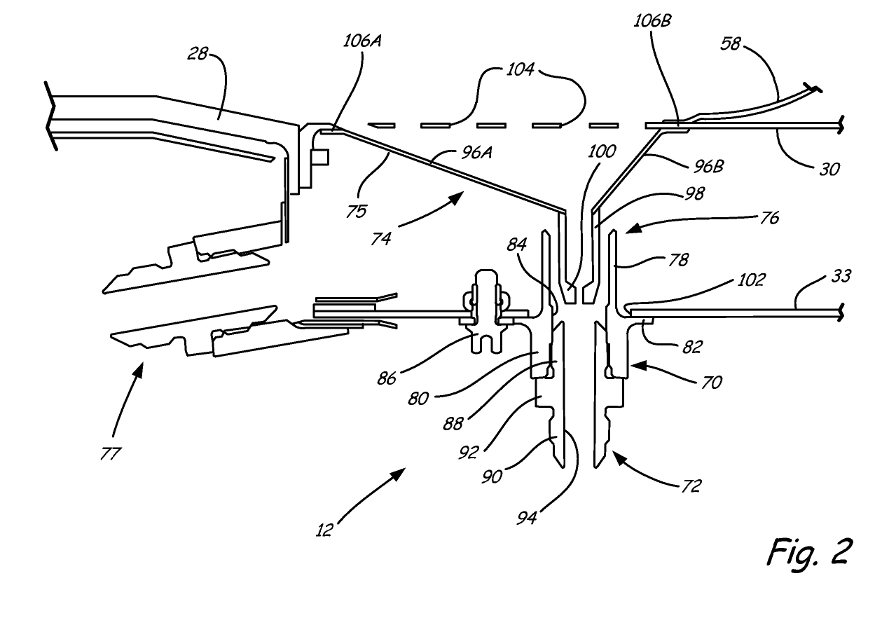

Fire enclosure 33 is jointed to APU 10 radially outward of combustor case 30. Fire enclosure 33 comprises a generally annular or cylindrical body that includes various shapes to accommodate incorporation of features such as drain assembly 12. Drain assembly 12 includes fitting 70, connector 72 and scupper 74. Scupper 74 is joined to combustor case 30 and comprises trough 75 for collecting fluid from combustor section 18. Fitting 70 connects to fire enclosure 33 and provides a receptacle for the trough of scupper 74. Connector 72 provides a means for joining a hose or some other containment or flow conducting means to fitting 70. As is discussed in greater detail with respect to FIG. 2, fitting 70 and scupper 74 form joint 76, which comprises a radial and axial expansion joint that permits combustor case 30 to move relative to fire enclosure 33 during operation of APU 10, while also limiting the amount of compressed air leaked from combustor case 30.

In various embodiments, compressor case 28 and turbine case 31 comprise bodies that have been manufactured, i.e. cast and machined. In various embodiments, combustor case 30 and exhaust case 32 comprise thin sheet-like bodies that have been shaped and formed. Compressor case 28, turbine case 31, combustor case 30 and exhaust case 32 are formed of various metal alloys, such as stainless steel, aluminum or titanium. Fire enclosure 33 comprises a thin sheet-like structure that is shaped and formed. In various embodiments, fire enclosure 33 is also made from various metal alloys as previously listed. However, in order to reduce the weight of APU 10, fire enclosure 33 is made from composite materials, such as a carbon fiber or fiber reinforced plastic composite, in other embodiments.

Inlet air A_{I} is drawn into APU 10 by operation of compressor section 14. Inlet air A_{I} continues through compressor section 14 to combustor case 30. Inside combustor case 30, compressed inlet air A_{I} enters combustor liner 56, which is connected to the inlet of turbine case 31. Fuel is injected into liner 56 through fuel nozzles (not shown) and ignited by an igniter (not shown) to carry out a combustion process to generate high energy gases for turbine section 16. The high energy gases flow to turbine section 16 where they are expanded and useful work is extracted by turbine section 16.

Compressor section 14 and turbine section 16 are co-axially connected by shaft 22. As exhaust air A_{E} passes through turbine section 16, turbine wheel 62 rotates shaft 22 through blades 64. Compressor wheel 52 is also coupled to turbine wheel 62 such that compressor blades 54 rotate to provide compressed air to combustor section 18 for carrying out the combustion process in combination with the fuel provided by the fuel nozzles. Shaft 22 extends from turbine wheel 62, through compressor wheel 52 and bearings 26. In other embodiments of the invention, drain assembly 12 can be used in other types of gas turbine engines having hot sections, such as industrial gas turbines, axial flow turbines and the like.

Operation of combustor section 18 produces heat. Temperatures within combustor section 18 can far exceed approximately 1,000 degrees Fahrenheit (˜538° Celsius). Temperatures outside of combustor liner 56 reach well above approximately 400 degrees Fahrenheit (˜204° Celsius) due to combustor section 18 and temperatures generated by compression of air in compressor section 14. Combustor section 18, therefore, comprises a hot zone within APU 10 where temperatures are above the flashpoint of fuel used in combustor section 18. In order to reduce the potential for hazard, the hot zone is encapsulated within fire enclosure 33 and other ducts of APU 10. Fitting 70, connector 72 and scupper 74 of drain assembly 12 prevent flames from escaping fire enclosure 33, and limit the amount of compressed inlet air A_{I} that escapes combustor case 30 from entering fire enclosure 33. Drain assembly 12 also permits expansion and contraction of fire enclosure 33 and combustor case 30.

Fire enclosure 33, compressor case 28, combustor case 30, exhaust case 32 are joined. Compressor case 28, combustor case 30 and exhaust case 32 form a flow path for inlet air A_{I} and exhaust air A_{E}. A flow path is provided into which ambient air A_{A} flows. Fire enclosure 33 also includes drain assembly 12, which includes drain fitting 70, drain connector 72 and drain scupper 74.

The combustion of air and fuel within combustor liner 56 and compression of air within compressor section 14 builds up heat and produces flames within APU 10. The flames are contained by combustor case 30 and exhaust case 32 while the heat can conduct through combustor case 30 and exhaust case 32. Due to the close proximity to liner 56 and heat generated by compressed air flow, combustor case 30 does not keep the temperatures outside of APU 10 below the flashpoint of fuel used in combustor section 18. Fire enclosure 33 provides a layer of containment to flames generated by fuel vapors which contact the exterior surface of combustor case 30 or exhaust case 32 and heat to ensure safe operation of APU 10 under all conditions. In particular, fire enclosure 33 provides a flame-proof heat zone within APU 10 to prevent the spread of heat and flames. Fire enclosure 33 is supported within APU 10 by connection to compressor case 28, combustor case 30 and exhaust case 32.

An E-seal provided on an eductor inlet connects to a duct within the aircraft to which APU 10 is mounted. Ambient air A_{A} is allowed into fire enclosure 33. Exhaust air A_{E} draws ambient air A_{A} through fire enclosure 33. Within APU 10, ambient air A_{A} cools combustor case 30. Ambient air A_{A} also cools the exhaust plume produced by exhaust air A_{E} outside of APU 10. Drain fitting 72 and drain scupper 74 of drain assembly 70 allow fuel from combustor 30 to drain out of APU 10 without entering fire enclosure 33. This eliminates mixing of fuel with water that collects in fire enclosure 33, which is drained separately form APU 10 via drain 77.

Joint 76 provides degrees of freedom for movement of fire enclosure 33. Joint 76 comprises a radial and axial expansion joint to provide freedom of movement to fire enclosure 33 in the radial direction. The ability of joint 76, as well as other joints, to absorb displacement of combustor case 30 and exhaust case 32 reduces the strain induced in fire enclosure 33 and preserves the stability of fire enclosure 33. This helps permit fire enclosure 33 to be made from lighter and more brittle material.

FIG. 2 shows expansion joint 76 connecting fire enclosure 33 to combustor case 30 within drain assembly 12. Drain assembly 12 includes fitting 70, connector 72 and scupper 74. Fitting 70 comprises first collar 78, second collar 80, base 82, passageway 84 and fastener 86. Connector 72 comprises first stem 88, second stem 90, flange 92 and through-bore 94. Scupper 74 includes first leg 96A, second leg 96B, cylindrical extension 98 and orifice 100. In one embodiment, fitting 70, connector 72 and scupper 74 are composed of a metal material, such as a stainless steel, aluminum or titanium alloy.

As illustrated in FIG. 2, drain assembly 12 is positioned between combustor case 30 and fire enclosure 33 at a position where combustor case 30 and fire enclosure 33 comprise generally parallel running annuluses; however, it will be understood that other configurations are contemplated within the scope of the invention. Fire enclosure 33 includes opening 102 into which drain fitting 70 is positioned. Base 82 is positioned around the exterior of opening 102 such that first collar 78 extends into fire enclosure 33. Fastener 86 is inserted through opposing bores in base 82 and fire enclosure 33 and secured with a bushing or nut to rigidly join fitting 70 to enclosure 33. Fastener 86 comprises one of several fasteners and in one embodiment three fasteners are used. Second collar extends from base 82 away from fire enclosure 33. Passageway 84 extends through first collar 78, second collar 80 and base 82 to link the interior and exterior of fire enclosure 33.

Drain scupper 74 is joined to a radially outward surface portion of combustor case 30 that includes perforations 104. First leg 96A and second leg 96B are joined to combustor case 30 via welding, brazing or some other such suitable fastening means at positions 106A and 106B, respectively. First leg 96A and second leg 96B slope away from combustor case 30 to join with cylindrical extension 98 at a trough, or low point, of scupper 74. First leg 96A is longer than second leg 96B such that angle of each leg with respect to combustor case 30 is different. The length of legs 96A and 96B are determined to position the trough at a low point within APU 10 based on the orientation of APU 10 when mounted in the aircraft in which it is used. Thus, in other embodiments, second leg 96B can be longer than first leg 96A. First leg 96A and second leg 96B terminate at a position radially outward of opening 102 in fire enclosure 33 and fitting 70. Cylindrical extension 98 extends from the trough into first collar 78 of fitting 70. Orifice 100 is positioned at the distal end of cylindrical extension 98 and aligns generally co-axially with passageway 84 of fitting 70 to feed connector 72.

Drain connector 72 is joined with fitting 70 to provide a means for removing fluid from combustor section 18. In the embodiment shown, connector 72 is configured to link with a hose to collect fluid from drain assembly 12. First stem 88 is inserted into second collar 80 of fitting 70. The outer diameter of first stem 88 is configured to form a force fit or interference fit with the inner diameter of second collar 80. First stem 88 includes ribs or other friction-increasing features for improving gripping with second collar 80. First stem 88 is inserted into second collar 80 until flange 92 engages collar 80. Second stem 90 extends from flange 92 to form a nipple, or fitting, around which a hose can be positioned. Second stem 90 includes friction-increasing means to enhance connection with the hose. The ends of first stem 88 and second stem 90 include tapered tips to facilitate insertion into collar 80 or a hose, respectively.

In the event un-burned fuel is present within combustor section 18, drain assembly 12 permits the fuel, or any other liquid, to pass through combustor case 30, fire enclosure 33 and out of APU 10. Fuel passes through perforations 104 and is funneled by first leg 96A and second leg 96B to cylindrical extension 98. Cylindrical extension 98 extends into first collar 78 to position orifice 100 near opening 102 in fire enclosure 33. As such, fuel drains into second collar 80. First collar 78 extends across a majority of the length of cylindrical extension 98 to prevent fuel from splashing or otherwise escaping fitting 70 inside fire enclosure 33, and to extend the length over which joint 76 is able to radially expand. The outer diameter of cylindrical extension 98 is smaller than the inner diameter of first collar 78 such axial displacement can be accommodated. Thus, if combustor case 30 grows or contracts during operation of APU 10, cylindrical extension 98 remains within collar 78 such that orifice 100 remains generally aligned with through-bore 94. After passing through orifice 100, fuel enters collar 80 and through-bore 94 of connector 72, whereby the fuel is permitted to drain out of APU 10. The fuel is then collected and disposed of as appropriate.

Expansion joint 76 maintain the fire-proof integrity of fire enclosure 33. Base 82 is flush-mounted to fire enclosure 33 to provide metal-to-metal contact that prevents flames from traveling through opening 102. Also, the magnitudes of the inner diameter of cylindrical extension 98, the inner diameter of through-bore 94 or the distance between the outer diameter of cylindrical extension 98 and the inner diameter of first collar 78 can be sized to provide a flame-quenching or flame-arresting path that smothers or otherwise deprives flames emitting from fire enclosure 33 of oxygen such that they are extinguished before exiting fire enclosure 33.

Furthermore, joint 76 preserves the efficiency of the gas turbine of APU 10. Combustor section 18 is pressurized by compressor section 14 during operation of APU 10. Turbine section 16 operates more efficiently as the pressure is maintained throughout the combustion process. Thus, any leakage of compressed inlet air A_{I} from combustor case 30 decreases the efficiency of APU 10. Orifice 100 comprises a small-diameter hole that is sized to permit liquid to pass through scupper 74, but to limit the amount of combustor air that escapes from combustor case 30. Due to the pressurization of combustor section 18, any amount of air leaked out of orifice 100 tends to travel back into fire enclosure 33. The presence of heated combustor air within fire enclosure 33 is undesirable as it is advantageous to maintain temperatures within enclosure 33 below the flashpoint of fuel. Air leaked into enclosure 33 from combustor case 30 is flushed from enclosure 33 by ambient air A_{A} introduced into enclosure 33.

Expansion joint 76 provided by drain assembly 12 prevents flames from escaping fire enclosure 12, limits the amount of compressed inlet air A_{I} that escapes combustor case 30, and permits expansion and contraction of fire enclosure 33 and combustor case 30. The evacuation of fire enclosure 33 by ambient air A_{A} allows fire enclosure 33 to be comprised of lightweight materials, such as composites, that reduce the overall weight of APU 10. Furthermore, the presence of flowing ambient air A_{A} in enclosure 33 eliminates the need for a seal between cylindrical extension 98 and first collar 78, further reducing the weight of APU 10. The elimination of a seal also facilitates manufacturing of drain assembly 12 as the tolerances of fitting 70 and scupper 74 can be increased.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. An auxiliary power unit comprising:
a gas turbine engine comprising:
a turbine;
a compressor;
a shaft supporting the turbine and the compressor;
a combustor section having:
an inlet for receiving compressed air from the compressor; and
an outlet for discharging gas to the turbine; and
an engine case circumscribing the turbine and the compressor, the engine case comprising a compressor section and a turbine section;
an exhaust case having:
an inlet connected to an outlet of the turbine section; and
an outlet for discharging exhaust from the gas turbine engine;
a combustor case having:
a first end connected to an outlet of the compressor section; and
a second end connected to the exhaust case;
a fire enclosure joined to the auxiliary power unit to circumscribe the combustor case; and
a drain assembly configured to permit fluid within the combustor case to drain out of the fire enclosure, the drain assembly including:
an expansion joint configured to permit relative movement between the fire enclosure and the combustor case.

2. The auxiliary power unit of claim 1 wherein:
the drain assembly further comprises:
a scupper extending outward from the combustor case to form a trough;
a drain fitting extending through an opening in the fire enclosure to align with the trough; and
an orifice extended from the trough by a cylindrical body penetrating into the drain fitting to form the expansion joint; and
the combustor case includes perforations within a perimeter of the scupper.

3. The auxiliary power unit of claim 2 wherein the scupper includes:
a first leg extending from the fire enclosure to the trough; and
a second leg extending from the fire enclosure to the trough;
wherein the first leg is longer than the second leg.

4. The auxiliary power unit of claim 2 wherein the drain fitting comprises:
a fitting body positioned within the opening in the fire enclosure, the fitting body comprising:
a base positioned outside of the fire enclosure;
a first collar extending inward from the base through the opening in the fire enclosure to circumscribe the orifice; and
a second collar extending outward from the base.

5. The auxiliary power unit of claim 4 wherein the fitting body is connected to the fire enclosure by a threaded fastener extending through the base.

6. The auxiliary power unit of claim 4 wherein the drain fitting further comprises:
a connector body comprising:
a first stem extending into the second collar;
a flange circumscribing the first stem;
a second stem extending from the flange; and
a through-bore extending through the first stem, the second stem and the flange.

7. The auxiliary power unit of claim 4 wherein:
the orifice is sized to limit combustor airflow out of the combustor case; and
the cylindrical body and the first collar are sized to limit combustor airflow from the orifice into the fire enclosure.

8. The auxiliary power unit of claim 1 wherein the fire enclosure is comprised of a composite material.

9. A drain system for a combustor section of a gas turbine engine, the drain system comprising:
a fire enclosure body having an opening;
a drain fitting connected to the fire enclosure body, the drain fitting comprising:
a first collar extending through the opening into the fire enclosure body;
a first stem extending from the first collar outside of the fire enclosure body; and
a passageway extending through the first collar and the first stem; and
a scupper disposed within the fire enclosure body, the scupper comprising:
a trough;
a cylindrical body extending from the trough; and
an orifice positioned on the cylindrical body and penetrating into the first collar to form an expansion joint.

10. The drain system of claim 9 wherein the drain fitting comprises:
a fitting body comprising:
the first collar;
a base positioned outside of the fire enclosure from which the first collar extends; and
a second collar extending outward from the base.

11. The drain system of claim 10 wherein the drain fitting further comprises:
a connector body comprising:
a second stem extending into the second collar;
a flange circumscribing the first stem;
the first stem extending from the flange; and
a through-bore extending through the first stem, the second stem and the flange.

12. The drain system of claim 9 wherein the scupper comprises:
a first leg extending from the fire enclosure to the trough; and
a second leg extending from the fire enclosure to the trough;
wherein the first leg is longer than the second leg.

13. The drain system of claim 9 and further comprising:
a combustor case joined to the scupper;
wherein the combustor case includes perforations to permit fluid from within the combustor case to drain into the trough.

14. The drain system of claim 13 wherein:
the orifice is sized to limit combustor airflow out of the combustor case; and
the cylindrical body and the first collar are sized to limit combustor airflow from the orifice into the fire enclosure.

15. A drain assembly for an auxiliary power unit having a hot zone formed by a combustor case of a gas turbine, the drain assembly comprising:
a fire enclosure encapsulating the hot zone of the combustor case;
a drain fitting connected to the fire enclosure; and
an orifice extended from the combustor case into the drain fitting to form an expansion joint.

16. The drain assembly of claim 15 wherein:
the drain fitting comprises:
a fitting body comprising:
a base positioned outside of the fire enclosure;
a first collar extending inward from the base through an opening in the fire enclosure to circumscribe the orifice; and
a second collar extending outward from the base; and
a connector body comprising:
a first stem extending into the second collar;
a flange circumscribing the first stem;
a second stem extending from the flange; and
a through-bore extending through the first stem, the second stem and the flange; and
a scupper that extends the orifice from the combustor case, the scupper comprising:
a first leg extending from the fire enclosure to a trough; and
a second leg extending from the fire enclosure to the trough;
wherein the first leg is longer than the second leg.
